(19) United States
(12) Patent Application Publication
(10) Pub. No.: US 2024/0328819 A1
(43) Pub. Date: Oct. 3, 2024

(54) AUTOMATIC DETECTION SYSTEM FOR A VEHICLE

(71) Applicant: GM GLOBAL TECHNOLOGY OPERATIONS LLC, Detroit, MI (US)

(72) Inventors: Roberto DELGADO BANUELOS, Sterling Heights, MI (US); Brian K. SAYLOR, South Lyon, MI (US)

(21) Appl. No.: 18/127,748

(22) Filed: Mar. 29, 2023

(51) Int. Cl. G01C 21/00; B60G 17/0165; B60K 31/00; B60Q 9/00; G01C 21/34

(52) U.S. Cl. CPC G01C 21/3822; B60G 17/0165; B60K 31/0008; B60Q 9/00; G01C 21/3461; G01C 21/3848; B60G 2400/823; B60G 2500/322; G08B 7/00

(57) ABSTRACT

An example detection system includes a sensor, a first module, and a second module. The sensor is positioned at at least one of a center of gravity of a vehicle and a wheel of the vehicle. The sensor is configured to measure (a) a first measurement of a parameter of the vehicle prior to the wheel contacting the obstacle and (b) a second measurement of the parameter of the vehicle while the vehicle is contacting the obstacle. The first module is configured to determine whether a change is present in the vehicle based on the first and second measurements, calculate a dimension of the obstacle, and store a global positioning system (GPS) location of the obstacle. The second module configured to actuate an actuator of the vehicle when the vehicle approaches the GPS location of the obstacle prior to the vehicle reaching the GPS location of the obstacle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to detection systems and more specifically, an automatic detection system of a vehicle.

A vehicle may travel along a road that has obstacles. Examples of obstacles include a speed bump, a pothole, or another obstacle. Some obstacles may be formed in the road intentionally. For example, the speed bump is intentionally formed in the road to cause vehicles to reduce a speed of the vehicle. Other obstacles may be formed in the road unintentionally. For example, the pothole is unintentionally formed in the road due to a breakdown of a material (e.g., concrete) of the road. Obstacles formed unintentionally in the road are often repaired to eliminate the obstacle.

The vehicle may include a set of wheels and a body. The set of wheels contact the road and support the body of the vehicle. As the vehicle travels along the road, one or more wheels of the set of wheels may encounter the obstacle and contact of the one or more wheels may be felt by occupants of the vehicle. For example, the disturbance may be a bump experienced by the occupants. In another example, the disturbance may be a sudden reduce in speed of the vehicle.

### SUMMARY

An example detection system for a vehicle detecting an obstacle includes a sensor, a first module, and a second module. The sensor is positioned at at least one of a center of gravity of the vehicle and a wheel of the vehicle. The sensor is configured to measure (a) a first measurement of a parameter of the vehicle prior to the wheel contacting the obstacle and (b) a second measurement of the parameter of the vehicle while the vehicle is contacting the obstacle. The first module is configured to determine whether a change is present in the vehicle based on the first measurement and the second measurement, calculate a dimension of the obstacle when the change is present based on the change in the vehicle, and store a global positioning system (GPS) location of the obstacle when the change is present. The second module is configured to actuate an actuator of the vehicle when the vehicle approaches the GPS location of the obstacle prior to the vehicle reaching the GPS location of the obstacle.

In one example, the second module is configured to elevate a nose of the vehicle prior to the wheel contacting the obstacle.

In one example, the second module is configured to elevate a nose of the vehicle prior to the wheel contacting the obstacle, based on the dimension of the obstacle.

In one example, the second module is configured to output at least one of an audible and a visual warning to a driver of the vehicle prior to the vehicle reaching the GPS location of the obstacle.

In one example, the second module is configured to reduce a speed of the vehicle prior to the vehicle reaching the GPS location of the obstacle while the vehicle is approaching the GPS location of the obstacle.

In one example, the second module is configured to reduce a speed of the vehicle prior to the vehicle reaching the GPS location of the obstacle while the vehicle is approaching the GPS location of the obstacle, based on the dimension of the obstacle and the GPS location of the obstacle.

In one example, the second module is configured to change a route of the vehicle to a route that does not include the GPS location of the obstacle.

In one example, the second module is configured to communicate the GPS location of the obstacle and the dimension of the obstacle to a third module of a second vehicle using at least one of vehicle to vehicle (V2V) communication and vehicle to infrastructure (V2I) communication. The third module is configured to actuate a second actuator of the second vehicle when the second vehicle approaches the GPS location of the obstacle prior to the second vehicle reaching the GPS location of the obstacle.

In one example, the second module is configured to communicate at least one of the GPS location of the obstacle and the dimension of the obstacle to a fourth module using V2I communication.

In one example, the obstacle is at least one of a speed bump and a pothole.

In one example, the sensor is positioned at the center of gravity of the vehicle.

In one example, the sensor is positioned at the wheel of the vehicle.

An example method for detecting an obstacle in a road is provided. The method includes measuring a first measurement of a parameter of a vehicle prior to a wheel of the vehicle contacting the obstacle. The method includes measuring a second measurement of the parameter of the vehicle while the vehicle is contacting the obstacle. The method includes determining whether a change is present in the vehicle based on the first measurement and the second measurement. The method includes calculating a dimension of the obstacle when the change is present based on the change in the vehicle. The method includes storing a GPS location of the obstacle when the change is present. The method includes actuating an actuator of the vehicle when the vehicle approaches the GPS location of the obstacle prior to the vehicle reaching the GPS location of the obstacle.

In one example, the actuating the actuator includes elevating a nose of the vehicle prior to the wheel contacting the obstacle.

In one example, the actuating the actuator includes elevating a nose of the vehicle prior to the wheel contacting the obstacle, based on the dimension of the obstacle.

In one example, the actuating the actuator includes outputting at least one of an audible and a visual warning to a driver of the vehicle prior to the vehicle reaching the GPS location of the obstacle.

In one example, the actuating the actuator includes reducing a speed of the vehicle prior to the vehicle reaching the GPS location of the obstacle while the vehicle is approaching the GPS location of the obstacle.

In one example, the actuating the actuator includes reducing a speed of the vehicle prior to the vehicle reaching the GPS location of the obstacle while the vehicle is approaching the GPS location of the obstacle, based on the dimension of the obstacle and the GPS location of the obstacle.

In one example, the actuating the actuator includes changing a route of the vehicle to a route that does not include the GPS location of the obstacle.

In one example, the method further includes communicating the GPS location of the obstacle and the dimension of the obstacle to a second vehicle using at least one of V2V communication and V2I communication. The method further includes actuating a second actuator of the second vehicle when the second vehicle approaches the GPS location of the obstacle prior to the second vehicle reaching the GPS location of the obstacle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic of an example vehicle traveling along an example road having a speed bump;

FIG. 2 is a schematic of an example vehicle traveling along an example road having a pothole;

FIG. 3 is a functional block diagram of an example detection system;

FIG. 4 is a functional block diagram of an example detection system;

FIG. 5 is a functional block diagram of an example detection system; and

FIGS. 6-7 are together a flowchart for a method of detecting an obstacle in a road.

In the drawings, reference numbers may be reused to identify similar and/or identical elements.

### DETAILED DESCRIPTION

A vehicle may encounter (e.g., travel over) an obstacle while traveling along a road. Examples of the obstacle include a speed bump, a pothole, and other types of obstacles.

The present application involves a detection system for a vehicle configured to detect the obstacle in a road. The vehicle includes a set of wheels and a body.

As the vehicle travels along the road, one or more wheels of the set of wheels may encounter the obstacle, and contact of the one or more wheels with the obstacle may be felt by occupants of the vehicle. In one example, encountering the obstacle may cause a collision between the body of the vehicle and the obstacle. More specifically, the body of the vehicle includes a bumper positioned at a front end of the vehicle. A frontmost portion of the bumper is referred to as a nose of the bumper. As the vehicle approaches the obstacle, the nose of the bumper may collide with the obstacle. The nose of the bumper may scrap the obstacle while the bumper travels over the obstacle.

The vehicle may include an input device for the driver of the vehicle to actuate as the vehicle encounters the obstacle. Examples of the input device include a button, a switch, a knob, or another suitable type of input device. The input device may be positioned on a steering wheel of the vehicle, a dashboard of the vehicle, an overhead console of the vehicle, or one or more other suitable locations in the vehicle. The driver of the vehicle may actuate the input device to notify the vehicle that the vehicle has encountered the obstacle. A module of the vehicle may store the location of the vehicle at a time the driver actuated the input device and perform a function (e.g., actuate an actuator of the vehicle) when the vehicle subsequently arrives at the location. Examples of functions include vertically raising the nose of the vehicle or otherwise changing a suspension characteristic of the vehicle to accommodate the obstacle, warning the driver of the upcoming obstacle, reducing a speed of the vehicle, changing a travel route of the vehicle to avoid the obstacle, or performing one or more other suitable functions. However, the time that that driver actuated the control may not be the precise location of the obstacle.

In view of the above, the detection system automatically detects obstacles in the road using sensors of the vehicle and precisely identifies a global positioning system (GPS) location of the obstacle, eliminating human error of manually recording the location of the obstacle via actuation of the input device.

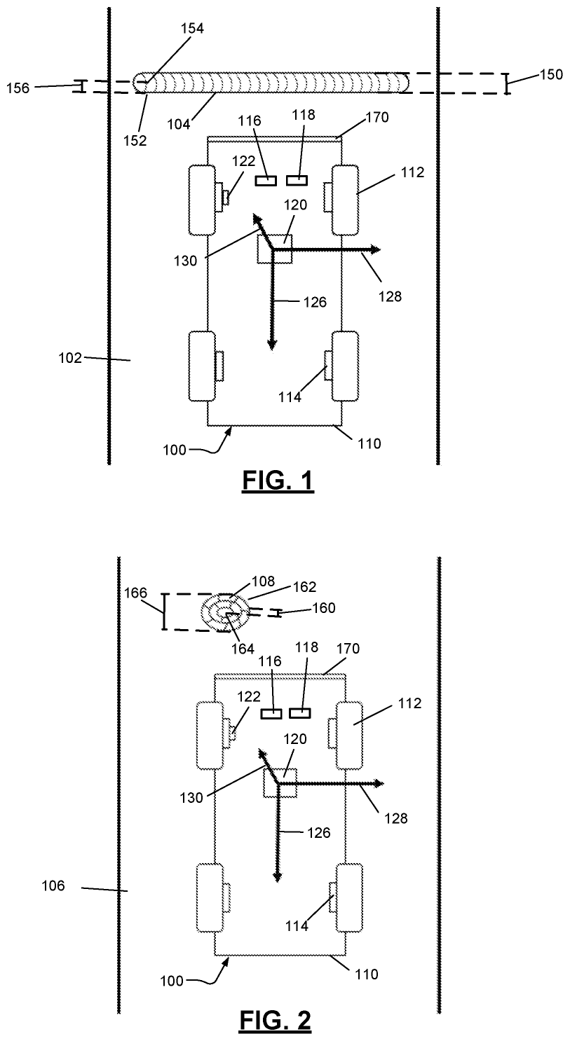

FIG. 1 is a schematic of a vehicle 100 traveling on a first road 102 with a first obstacle 104. FIG. 2 is a schematic of the vehicle 100 traveling on a second road 106 with a second obstacle 108. In the illustrated example, the first obstacle 104 is a speed bump in the first road 102 and the second obstacle 108 is a pothole in the second road 106. However, the present application is also applicable to other types of obstacles.

The vehicle 100 may be a low-riding vehicle (e.g., a coupe, a sports vehicle, etc.), a sedan, a small sport utility vehicle (SUV), a large SUV, a truck or another type of vehicle. The vehicle 100 may be an autonomous vehicle or a non-autonomous vehicle.

The vehicle 100 may include a body 110, a set of wheels 112, and a set of shock absorbers 114. Each shock absorber 114 may be positioned at one wheel 112 of the vehicle 100. The shock absorbers 114 are attached to the body 110 and the wheels 112 of the vehicle 100. The shock absorbers 114 dampen impulses exerted on the wheels 112 of the vehicle 100 to minimize vertical movement of the body 110 of the vehicle 100 as the vehicle 100 travels along the road.

The vehicle 100 may include a display 116 and a speaker 118. The display 116 may be a head unit screen, a cluster screen, or another suitable display in the vehicle 100. In various implementations, the display 116 may be a touchscreen display. The display 116 may be used to display information, adjust features or settings of the vehicle, present prompts to occupants of the vehicle 100, and to perform one or more other functions. The speaker 118 may be used to output audible sounds and to perform one or more functions.

The vehicle 100 may include a first sensor 120, a second sensor 122, or both the first and second sensors 120, 122. The first sensor 120 may be a gyroscopic sensor disposed at approximately a center of gravity of the vehicle 100, or another suitable location of the vehicle 100. The first sensor 120 is configured to measure movement of the body 110 of the vehicle 100 and may be a 6 degrees of freedom (DOF) gyroscopic sensor. More specifically, the first sensor 120 is configured to measure a linear acceleration of the vehicle 100 along an X axis 126, a Y axis 128, and a Z axis 130, and a moment about the X, Y, and Z axes 126, 128, 130. The X, Y and Z axes 126, 128, 130 are perpendicular to each other. The X axis is along a longitudinal direction of the vehicle, the Y axis is a lateral direction of the vehicle, and the Z axis is a vertical direction.

The second sensor 122 may be a displacement sensor, a gravitational (G)-force sensor, or another suitable sensor. The second sensor 233 may be disposed at one wheel 112 of the vehicle 100 or in another suitable location of the vehicle 100.

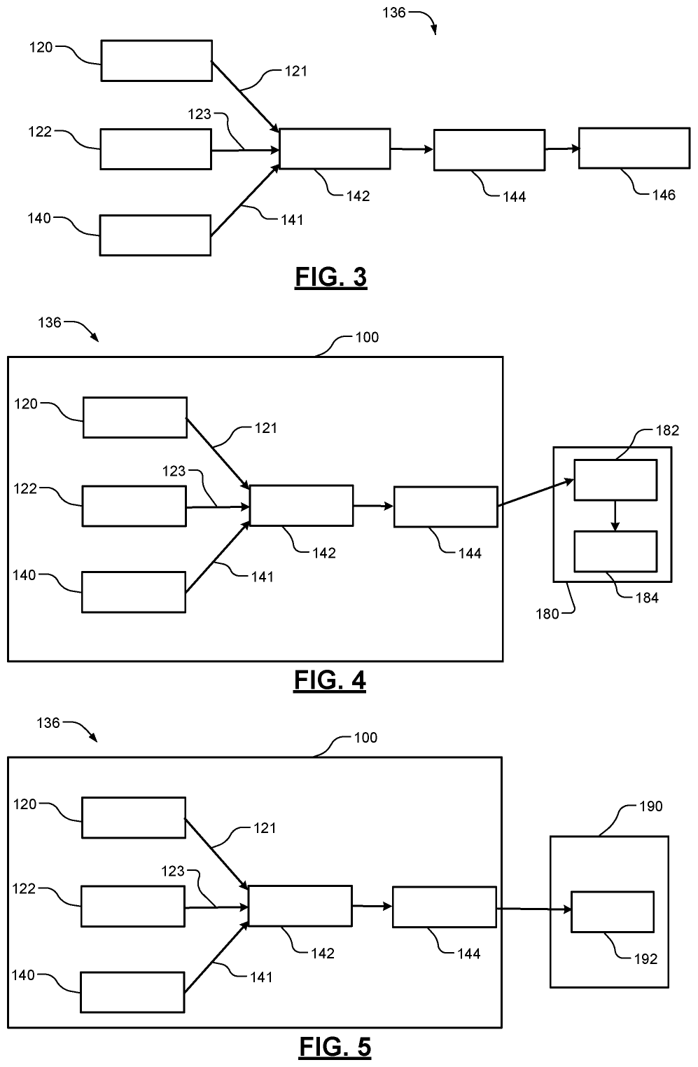

FIG. 3 is a functional block diagram of an example detection system 136 of the vehicle 100. The detection system 136 can detect an obstacle (e.g., first obstacle 104, second obstacle 108) in a road (e.g., first road 102, second road 106) without user input indicative of the presence of the obstacle in the road, such as via user actuation of the input device. The detection system 136 may include the first sensor 120, the second sensor 122, or both the first and second sensors 120, 122. Additionally, the detection system 136 may include a global positioning system (GPS) module 140, a first module 142 (e.g., detection module) and a second module 144 (e.g., actuator module).

The first sensor 120 is configured to measure first values 121 of a first parameter of the vehicle 100. More specifically, the first sensor 120 is configured to measure a first measurement of a first parameter prior to encountering the obstacle and a second measurement of the first parameter while the vehicle 100 is encountering the obstacle. The first measurement is measured prior to the wheels 112 of the vehicle 100 contacting the obstacle in the road. The second measurement of the vehicle 100 is measured while the wheels 112 of the vehicle 100 are contacting the obstacle in the road. The first parameter includes at least one of a linear acceleration of the vehicle 100 along the X, Y, and Z axes 126, 128, 130, and a moment about the X, Y, and Z axes 126, 128, 130 measured by the first sensor 120.

The second sensor 122 is configured to measure second values 123 of a second parameter of the vehicle 100. More specifically, the second sensor 122 is configured to measure a third measurement of a second parameter prior to the vehicle 100 encountering the obstacle and a fourth measurement of the second parameter while the vehicle 100 is encountering the obstacle. The third measurement is measured prior to the wheels 112 of the vehicle 100 contacting the obstacle. The fourth measurement is measured while the wheels 112 of the vehicle 100 are contacting the obstacle.

In the example of the displacement sensor, the second sensor 122 may be positioned at one of the shock absorbers 114. The second parameter may be a displacement measurement, such as a distance between the body 110 of the vehicle 100 and one of the shock absorbers 114. In the example of the G-force sensor, the second parameter may be an acceleration measurement at one of the wheels 112.

The GPS module 140 is configured to determine a GPS location 141 of the obstacle while at least one wheel 112 of the vehicle 100 is contacting the obstacle. The GPS location 141 of the obstacle is the location of a center of the obstacle. For example, the center of the first obstacle 104 is at a peak 154 or vertical top of the first obstacle 104 and the center of the second obstacle 108 is at a trough 164 or vertical bottom of the second obstacle 108. The GPS location 141 may be in a decimal degrees (DD) format, in a degrees and decimal minutes (DDM) format, in a degrees, minutes and seconds (DMS) format, or another suitable format.

The first module 142 is configured to receive the first and second measurements from the first sensor 120, the third and fourth measurements from the second sensor 122, or the first, second, third, and fourth measurements from both the first and the second sensors 120, 122. The first module 142 is configured to receive the GPS location 141 from the GPS module 136 of the vehicle 100. The first module 142 is configured to detect the presence of the obstacle based on a change in at least one of the first parameter and the second parameter of the vehicle 100. In one example, the first module 142 is configured to determine the change in the first parameter of the vehicle 100 based on a difference (change) between the first and second measurements of the first sensor 120. In another example, the first module 142 is configured to determine the change in the second parameter of the vehicle 100 based on a difference (change) between the third and fourth measurements of the second sensor 122. In yet another example, the first module 142 is configured to determine the change in the first and second parameters of the vehicle 100 based on a difference between the first and second measurements of the first sensor 120 and a difference between the third and fourth measurements of the second sensor 122. The first module 142 may detect the presence of the obstacle when the change is greater than a predetermined value. The first module 142 may not detect the presence of the obstacle when the change is less than the predetermined value. The first module 142 detects whether the obstacle is present in the road without user input indicative of the presence of the obstacle in the road.

The first module 142 is configured to determine dimensions of the obstacle when the first module 142 detects the presence of the obstacle (e.g., the change is greater than the predetermined value). The first module 142 may determine dimensions of the obstacle based on the change in the vehicle 100. In the illustrated example of FIG. 1, a first dimension 150 for the first obstacle 104 is a height measured from a first ground surface 152 of the first road 102 to the peak 154 of the first obstacle 104. A second dimension 156 for the first obstacle 104 is a width of the first obstacle 104 measured at the first ground surface 152 of the first road 102. In the illustrated example of FIG. 2, a third dimension 160 for the second obstacle 108 is a depth measured from a second ground surface 162 of the second road 106 to the trough 164 of the second obstacle 108. A fourth dimension 166 is a diameter of the second obstacle 108 measured at the second ground surface 162 of the second road 106. The first module 142 may determine the first, second, third, and/or fourth dimensions, for example, using one or more equations and/or lookup tables that relate values of the change to values of the first, second, third, and fourth dimensions.

The first module 142 is configured to determine whether one or more of the dimensions of the obstacle is/are greater than a predetermined dimension. For example, the predetermined dimension for the first dimension 150 may be about 100 millimeters (mm) or another suitable value. The predetermined dimension for the second dimension 156 may be about 250 mm or another suitable value. The predetermined dimension for the third dimension 160 may be about 75 mm or another suitable value. The predetermined dimension for the fourth dimension 166 may be about 3600 mm or another suitable value. However, the predetermined dimensions are calibratable and may be another suitable dimension. When at least one dimension of the obstacle exceeds the respective predetermined dimension, the first module 142 may classify obstacle as a “high” or “large” obstacle. When all of the dimension of the obstacle are less than the respective predetermined dimensions, the first module 142 may classify the obstacle as a “low” or “small” obstacle.

In one example, the display 116 of the vehicle 100 is configured to display a prompt to save the GPS location of the obstacle when at least one dimension exceeds the respective predetermined dimension (e.g., the obstacle is a high or large obstacle). The prompt requests the user (e.g., driver or another occupant of the vehicle 100) to select an option to save the GPS location 141 and an option to delete the GPS location 141 of the obstacle. When the user selects the option to save the GPS location 141 of the obstacle, the first module 142 is configured to store the GPS location 141 of the obstacle in memory.

In some examples, a location of the obstacle may have already been manually entered and stored in memory, such as by the driver or another occupant of the vehicle actuating the input device when the vehicle 100 previously encountered the obstacle. The first module 142 is configured to replace the manually entered location with the GPS location when the manually entered location and the GPS location are within a predetermined distance. For example, the predetermined distance may range from about 25 meters (m) to about 50 m. However, the predetermined distance is calibratable and may be another suitable distance.

The second module 144 is configured to receive the first, second, third, and fourth dimensions and the GPS location 141 of the obstacle from the first module 142. The second module 144 is configured to actuate an actuator 146 of the vehicle 100 when the vehicle 100 approaches the GPS location of the obstacle prior to the vehicle 100 reaching the GPS location of the obstacle.

In one example, the second module 144 is a front ride height control module. When the vehicle 100 subsequently encounters the obstacle, the second module 144 is configured to vertically elevate a nose (front) 170 of the vehicle 100 or otherwise adjust a suspension of the vehicle 100 based on at least one dimension and the GPS location 141 of the obstacle. For example, each time the vehicle 100 is approaching and is within a predetermined distance of the GPS location 141 of the obstacle, the second module 144 is configured to vertically elevate the nose 170 of the vehicle 100. The second module 144 is configured to vertically elevate the nose 170, based on the dimensions of the obstacle, such that the nose 170 of the vehicle 100 clears the obstacle without contacting the obstacle when the vehicle 100 encounters the obstacle. The second module 144 may determine a distance to elevate the nose 170, for example, based on one or more of the first, second, third, and fourth dimensions. The second module 144 may determine the distance to elevate the nose 170, for example, using one or more equations and/or lookup tables that relate one or more of the dimensions to elevation distances.

In another example, the second module 144 is configured to warn an occupant (e.g., driver, passenger) of the vehicle 100 of the obstacle based on at least one dimension of the obstacle and the GPS location 141 of the obstacle. For example, the second module 144 may output a warning when one or more of the dimensions are greater than a predetermined dimension. The second module 144 is configured to warn the occupant before the vehicle arrives at the GPS location of the obstacle. The warning may be an audible warning via the speaker 118, a visual warning via one or more visual output devices (e.g., display 116), a haptic warning via one or more components (e.g., steering wheel, seat) that contact the driver, or another suitable type of warning. The warning may indicate severities based on the dimensions of the obstacle. Accordingly, one or more occupants are alerted that the vehicle 100 will encounter the obstacle and may experience a disturbance. Thus, the occupants can prepare themselves for the vehicle 100 to encounter the obstacle or steer the vehicle 100 to avoid the obstacle.

In another example, the second module 144 is configured to reduce a speed of the vehicle 100 prior to the vehicle 100 subsequently encountering the obstacle, based on one or more of the dimensions and the GPS location 141 of the obstacle. In other words, the second module 144 is configured to reduce the speed of the vehicle 100 prior to the vehicle 100 reaching the GPS location of the obstacle. The second module 144 may slow the speed of the vehicle 100, for example, by decreasing torque output of one or more electric motors and/or an internal combustion engine. Additionally or alternatively, the second module 144 may slow the speed of the vehicle 100 by applying friction brakes of the vehicle 100. The second module 144 may select the speed based on the dimensions of the obstacle. In one example, as the dimensions increase, the second module 144 may select a lower speed and vice versa.

In another example, the second module 144 is configured to change a route of the vehicle 100 prior to the vehicle 100 reaching the obstacle, based on at least one dimension and the GPS location 141 of the obstacle. For example, when one or more of the dimensions are greater than the predetermined dimension (e.g., the obstacle is a high or large obstacle), the second module 144 may change the route of the vehicle 100 to avoid the GPS location 141 of the obstacle. In some configurations, the obstacle may be in one lane of the road and a second lane of travel may be free of the obstacle. The vehicle 100 may initiate a lane change or alert the driver to initiate a lane change to the second lane to avoid encountering the obstacle.

In other configurations, the occupant of the vehicle 100 may activate a navigation system of the vehicle 100. The occupant may input a destination and the navigation system may identify a first route for the vehicle 100 to travel to reach the destination. If the first route includes encountering the obstacle, the second module 144 may identify a second route for the vehicle 100 to travel to reach the destination. The second route does not pass through the GPS location 141 of the obstacle. The second module 144 may alert the occupant that the first route includes encountering the obstacle and may provide an option on the display 116 of the vehicle 100 to select the first route or the second route. Alternatively, the second module 144 may automatically select the second route to avoid the obstacle.

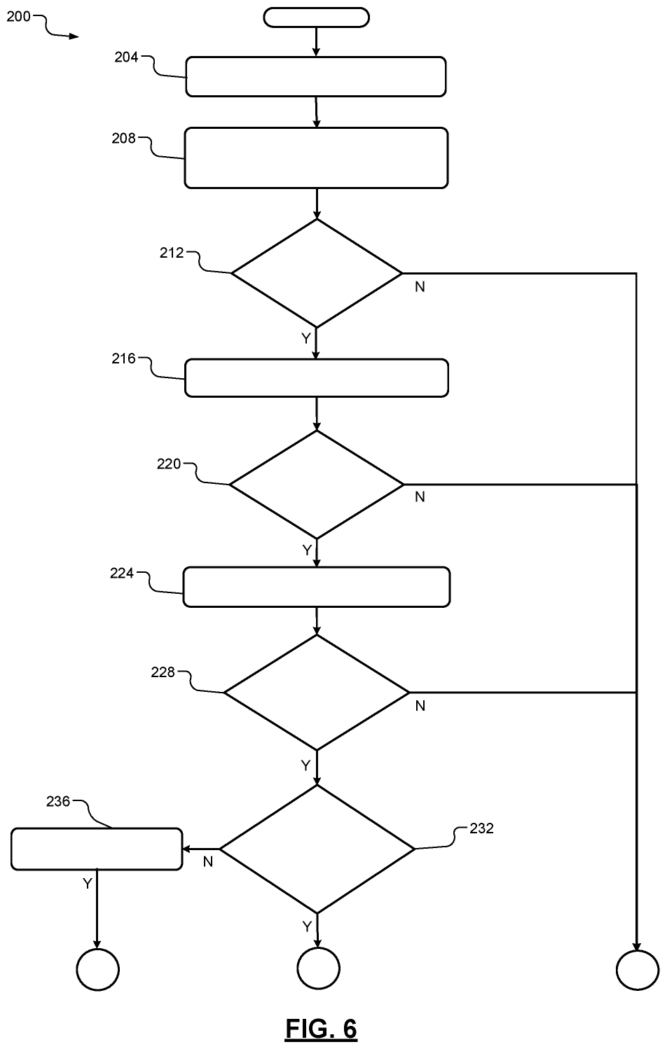

In the example shown in FIG. 4, the second module 144 is configured to communicate the dimensions of the obstacle and the GPS location 141 of the obstacle to a second vehicle 180. More specifically, the second module 144 is configured to communicate to a third module 182 of the second vehicle 180. The GPS location 141 may be communicated using vehicle to vehicle (V2V) communication, vehicle to infrastructure (V2I) communication, or another communication method. The second vehicle 180 may be an autonomous vehicle or another suitable type of vehicle. Using V2V communication, the dimension and GPS location 141 of the obstacle may be directly communicated to the second vehicle 180. Using V2I communication, the dimension and GPS location 141 of the obstacle may be broadcasted to the second vehicle 180 and one or more other vehicles. The third module 182 is configured to perform all the functions described for the second module 144 of the vehicle 100. For example, the third module 182 is configured to actuate a second actuator 184 of the second vehicle 180 when the second vehicle 180 approaches the GPS location of the obstacle prior to the second vehicle 180 reaching the GPS location of the obstacle.

In the example shown in FIG. 5, the second obstacle 108 is the pothole, or another road hazard and the second module 144 is configured to communicate the dimensions and the GPS location 141 to a roadway maintenance department 190. More specifically, the second module 144 of the vehicle 100 is configured to communicate to a fourth module 192 at the roadway maintenance department 190. The second module 144 may communicate to the fourth module 192, for example, using V2I communication. In this manner, the roadway maintenance department 190 is alerted of the second obstacle 108. In some configurations, the second module 144 is configured to communicate the dimensions and GPS location 141 of only large obstacles (e.g., at least one dimension exceeds the predetermined dimension). In other configurations, the second module 144 is configured to communicate the dimensions and GPS location of all second obstacles 108 (e.g., large and small obstacles).

The GPS location 141 of the second obstacle 108 can be used by the roadway maintenance department 190 to precisely locate the obstacle. The dimensions of the second obstacle 108 can be used by the roadway maintenance department 190 to assess the severity of the second obstacle 108. Once notified of the second obstacle 108, the roadway maintenance department 190 can begin planning and coordinating a repair for the second obstacle 108, and thereby improve wait times for the repair and reduce damage caused by the second obstacle 108 to other vehicles.

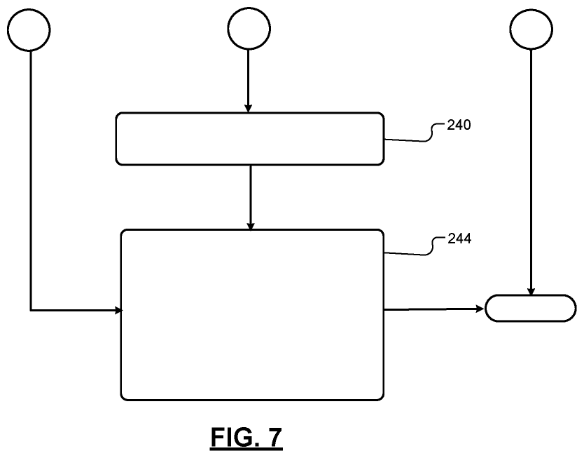

FIGS. 6-7 is a method 200 for a vehicle 100 detecting an obstacle in the road using the example detection system 136.

At 204, the first sensor 120 measures the first measurement of the first parameter of the vehicle 100, the second sensor 122 measures the third measurement of the second parameter of the vehicle 100, or both the first sensor 120 measures the first measurement of the first parameter and the second sensor 122 measures the third measurement of the second parameter. The first and third measurements are measured prior to the vehicle 100 encountering the obstacle.

At 208, the vehicle 100 is encountering the obstacle. The first sensor 120 measures the second measurement of the first parameter of the vehicle 100, the second sensor 122 measures the fourth measurement of the second parameter of the vehicle 100, or both the first sensor 120 measures the second measurement of the first parameter and the second sensor 122 measures the fourth measurement of the second parameter of the vehicle 100. The second and fourth measurements are measured while the wheels 112 of the vehicle are contacting the center (e.g., peak 154, trough 164) of the obstacle in the road. The GPS module 140 determines the GPS location 141 of the obstacle. The GPS location 141 is a location of the obstacle at the center (e.g., peak 154, trough 164) of the obstacle.

At 212, the first module 142 receives the (a) first and second measurements, (b) third and fourth measurements, or (c) the first, second, third, and fourth measurements. The first module 142 determines one or more changes in the parameter(s) of the vehicle 100 based on at least one of (a) a difference between the first and second measurements and (b) a difference between the third and fourth measurements. The change may be determined when the differences between the first and second measurements or the third and fourth measurements is greater than the predetermined value. In other words, the first module 142 detects the presence of the obstacle when the change is greater than the predetermined value. If 212 is false (e.g., there was no change in the vehicle 100), the method ends. If 212 is true (e.g., there was a change in the vehicle 100), the method continues to 216.

At 216, the first module 142 determines at least one dimension (e.g., first dimension 150, second dimension 156, third dimension 160, fourth dimension 166) of the obstacle based on the change in the vehicle 100. The first module 142 may determine the at least one dimensions when the change is present, for example, using one or more equations and/or lookup tables that relate values of the change to values of the at least one dimension.

At 220, the first module 142 determines whether the at least one dimension exceeds the predetermined dimension. For example, the threshold may be 100 mm. If 220 is false (e.g., at least one dimension does not exceed the respective threshold), the method ends. If 220 is true (e.g., at least one dimension exceeds the respective threshold), the method continues to 224.

At 224, the display 116 of the vehicle 100 displays a prompt to save the GPS location 141 of the obstacle. The display 116 may display the prompt on a head unit screen, a cluster screen, or another suitable screen of the vehicle. The prompt requests the user (e.g., driver or another occupant of the vehicle) to select the option to save the GPS location 141 or the option to delete the GPS location 141 of the obstacle.

At 228, the first module 142 determines whether the user selected the option to save the GPS location 141 of the obstacle. If 228 is false (e.g., the user did not save the GPS location 141 of the obstacle), the method ends. If 228 is true (e.g., the user saved the GPS location 141 of the obstacle), the method continues to 232.

At 232, the first module 142 determines whether a manual entry of the location of the obstacle exists. For example, the location of the obstacle may have been manually entered by a user (e.g., the driver of the vehicle) by actuating an input device when the vehicle 100 previously encountered the obstacle. If 232 is false (e.g., a manual entry does not exist), the method continues to 236. If 232 is true (e.g., a manual entry does exist), the method continues to 240.

At 236, the first module 142 stores the GPS location 141 of the obstacle in memory. The GPS location 141 is the location of the obstacle at the center (e.g., peak 154, trough 164) of the obstacle.

At 240, the first module 142 replaces the manual entry of the location of the obstacle with the GPS location 141. In some configurations, the first module 142 is configured to replace the manually entered location with the GPS location 141 when the manually entered location and the GPS location 141 are within a predetermined distance.

At 244, the second module 144 performs at least one of (a) elevating a nose 170 of the vehicle 100, (b) warning the occupant of the vehicle 100 of the obstacle, (c) reducing a speed of the vehicle 100, (d) changing a route of the vehicle 100, (e) communicating to the second vehicle 180, and (f) communicating to the roadway maintenance department 190.

In some configurations, the second module 144 vertically elevates the nose 170, or otherwise adjusts the suspension characteristic of the vehicle 100 based on the GPS location 141 of the obstacle and at least one dimension of the obstacle. The second module 144 may determine the distance to elevate the nose 170, for example, using one or more equations and/or lookup tables that relate the at least one dimension to an elevation distance.

In some configurations, the second module 144 warns the occupant of the vehicle 100 of the obstacle based on the at least one dimension of the obstacle and the GPS location 141 of the obstacle. The second module 144 warns the occupant before the vehicle 100 arrives at the GPS location 141 of the obstacle. The warning may be an audible warning via the speaker 118, a visual warning via one or more visual output devices (e.g., display 116), a haptic warning via one or more components contacting the driver, or another suitable type of warning. The warning may indicate severities based on the at least one dimension of the obstacle.

In some configurations, the second module 144 reduces the speed of the vehicle 100 prior to the vehicle 100 subsequently encountering the obstacle, based on the GPS location 141 of the obstacle and the at least one dimension of the obstacle. The second module 144 may reduce the speed of the vehicle, for example, by decreasing torque output of one or more electric motors and/or an internal combustion engine. Additionally or alternatively, the second module 144 may reduce the speed of the vehicle by applying friction brakes of the vehicle 100.

In some configurations, the second module 144 changes the route of the vehicle 100 prior to the vehicle reaching the obstacle, based on the GPS location 141 of the obstacle and the at least one dimension of the obstacle. For example, when the at least one dimension is greater than the predetermined dimension (e.g., the obstacle is a high or large obstacle), the second module 144 may change the route of the vehicle 100 to avoid the GPS location 141 of the obstacle.

In some configurations, the second module 144 communicates the at least one dimension and the GPS location 141 of the obstacle to the third module 182 of the second vehicle 180. The third module 182 of the second vehicle 180 may perform all the functions described for the second module 144 of the vehicle 100.

In some configurations, the obstacle is the second obstacle 108, or another road hazard and the second module 144 communicates the at least one dimension and the GPS location 141 to the fourth module 192 of the roadway maintenance department 190. The second module 144 may communicate with the fourth module 192 using V2I communication or another suitable form of communication. In some examples, the second module 144 is configured to communicate the at least one dimension and GPS location 141 of only large obstacles (e.g. dimension exceeds the threshold). In other examples, the second module 144 is configured to communicate the at least one dimension and GPS location of all obstacles (e.g., large and small obstacles).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A detection system for a vehicle detecting an obstacle, the detection system comprising:
a sensor positioned at at least one of a center of gravity of the vehicle and a wheel of the vehicle, the sensor configured to measure (a) a first measurement of a parameter of the vehicle prior to the wheel contacting the obstacle and (b) a second measurement of the parameter of the vehicle while the vehicle is contacting the obstacle;
a first module configured to:
determine whether a change is present in the vehicle based on the first measurement and the second measurement,
calculate a dimension of the obstacle when the change is present based on the change in the vehicle, and
store a global positioning system (GPS) location of the obstacle when the change is present; and
a second module configured to actuate an actuator of the vehicle when the vehicle approaches the GPS location of the obstacle prior to the vehicle reaching the GPS location of the obstacle.

2. The detection system of claim 1, wherein the second module is configured to elevate a nose of the vehicle prior to the wheel contacting the obstacle.

3. The detection system of claim 1, wherein the second module is configured to elevate a nose of the vehicle prior to the wheel contacting the obstacle, based on the dimension of the obstacle.

4. The detection system of claim 1, wherein the second module is configured to output at least one of an audible and a visual warning to a driver of the vehicle prior to the vehicle reaching the GPS location of the obstacle.

5. The detection system of claim 1, wherein the second module is configured to reduce a speed of the vehicle prior to the vehicle reaching the GPS location of the obstacle while the vehicle is approaching the GPS location of the obstacle.

6. The detection system of claim 1, wherein the second module is configured to reduce a speed of the vehicle prior to the vehicle reaching the GPS location of the obstacle while the vehicle is approaching the GPS location of the obstacle, based on the dimension of the obstacle and the GPS location of the obstacle.

7. The detection system of claim 1, wherein the second module is configured to change a route of the vehicle to a route that does not include the GPS location of the obstacle.

8. The detection system of claim 1, wherein:
the second module is configured to communicate the GPS location of the obstacle and the dimension of the obstacle to a third module of a second vehicle using at least one of vehicle to vehicle (V2V) communication and vehicle to infrastructure (V2I) communication; and
the third module is configured to actuate a second actuator of the second vehicle when the second vehicle approaches the GPS location of the obstacle prior to the second vehicle reaching the GPS location of the obstacle.

9. The detection system of claim 1, wherein the second module is configured to communicate at least one of the GPS location of the obstacle and the dimension of the obstacle to a fourth module using V2I communication.

10. The detection system of claim 1, wherein the obstacle is at least one of a speed bump and a pothole.

11. The detection system of claim 1, wherein the sensor is positioned at the center of gravity of the vehicle.

12. The detection system of claim 1, wherein the sensor is positioned at the wheel of the vehicle.

13. A method for detecting an obstacle in a road, the method comprising:
measuring a first measurement of a parameter of a vehicle prior to a wheel of the vehicle contacting the obstacle;
measuring a second measurement of the parameter of the vehicle while the vehicle is contacting the obstacle;
determining whether a change is present in the vehicle based on the first measurement and the second measurement;
calculating a dimension of the obstacle when the change is present based on the change;
storing a GPS location of the obstacle in response to a determination that the change is present; and
actuating an actuator of the vehicle when the vehicle approaches the GPS location of the obstacle prior to the vehicle reaching the GPS location of the obstacle.

14. The method of claim 13, wherein the actuating the actuator includes elevating a nose of the vehicle prior to the wheel contacting the obstacle.

15. The method of claim 13, wherein the actuating the actuator includes elevating a nose of the vehicle prior to the wheel contacting the obstacle, based on the dimension of the obstacle.

16. The method of claim 13, wherein the actuating the actuator includes outputting at least one of an audible and a visual warning to a driver of the vehicle prior to the vehicle reaching the GPS location of the obstacle.

17. The method of claim 13, wherein the actuating the actuator includes reducing a speed of the vehicle prior to the vehicle reaching the GPS location of the obstacle while the vehicle is approaching the GPS location of the obstacle.

18. The method of claim 13, wherein the actuating the actuator includes reducing a speed of the vehicle prior to the vehicle reaching the GPS location of the obstacle while the vehicle is approaching the GPS location of the obstacle, based on the dimension of the obstacle and the GPS location of the obstacle.

19. The method of claim 13, wherein the actuating the actuator includes changing a route of the vehicle to a route that does not include the GPS location of the obstacle.

20. The method of claim 13, further comprising:
communicating the GPS location of the obstacle and the dimension of the obstacle to a second vehicle using at least one of V2V communication and V2I communication; and
actuating a second actuator of the second vehicle when the second vehicle approaches the GPS location of the obstacle prior to the second vehicle reaching the GPS location of the obstacle.
